(19) United States
(12) Patent Application Publication
(10) Pub. No.: US 2009/0057534 A1
(43) Pub. Date: Mar. 5, 2009

(54) LIGHT SOURCE DEVICE

(75) Inventors: Chao-Wen Liu, Hsinchu (TW); Yung-Lung Liu, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CORETRONIC CORPORATION, Hsinchu (TW)

(21) Appl. No.: 12/040,932

(22) Filed: Mar. 3, 2008

(30) Foreign Application Priority Data
Aug. 28, 2007 (TW) 96131805

(51) Int. Cl. G01J 1/32

(52) U.S. Cl. 250/205

(57) ABSTRACT

The invention discloses light source devices applied in backlight modules of image display panels. The light source device includes a current source unit generating a driving current, a plurality of light emitting units coupled in series to the current source unit, a plurality of current shunts corresponding to the light emitting units respectively and providing current bypasses for the driving current to bypass the corresponding light emitting units, a plurality of light sensing units sensing the brightness of the light emitting units, and a control unit generating a plurality of current shunt control signals for separately controlling the current shunts. Each of the current shunt control signals is generated according to the sensed brightness of the corresponding light emitting unit and is used in controlling the conduction statement of the current bypass provided by the corresponding current shunt.

### BACKGROUND OF THE INVENTION

1. Field of the Invention

The present invention relates to light source devices and particularly relates to light source devices applied in backlight modules.

2. Description of the Related Art

The backlight module adopted in liquid crystal display (LCD) normally comprises a light source device implemented by a light emitting element array. The light emitting element array is composed of a plurality of light emitting elements. FIG. 1 illustrates a conventional light emitting element array. In this case, it is a 4×4 light emitting elements array. Each column of the light emitting element array includes a plurality of light emitting elements (LEDs) coupled in series. The LEDs of the same column share a single driving current I.

The drawback of the conventional light emitting element array shown in FIG. 1 is that the brightness of each of the LEDs cannot be controlled separately. Referring to FIG. 1, the LEDs of the same column share a single driving current I and, in an ideal case, the LEDs of the same column have the same brightness. However, the electronic characteristics of the LEDs may be different because of manufacture process deviation. The LED with electronic characteristic different from the other LEDs in the same column has different brightness compared to the other LEDs in the same column. Moreover, when any LED malfunctions, the other LEDs of the same column stop illuminating because the current path of the driving current I is blocked by the malfunctioned LED.

Therefore, it is desirable to provide a new light source device to separately control each of the light emitting elements and uniform the brightness of the light emitting element array.

### BRIEF SUMMARY OF THE INVENTION

One embodiment of the invention provides light source devices applied in backlight modules of image display panels. The light source device includes a current source unit generating a driving current, a plurality of light emitting units, a plurality of current shunts, a plurality of light sensing units and a control unit. The light emitting units are coupled in series to the current source unit. Each of the current shunts is corresponding to one of the light emitting units and provides a current bypass for the driving current to bypass the corresponding light emitting unit. Each of the light sensing units is corresponding to one of the light emitting units and senses the brightness of the corresponding light emitting unit. The control unit generates a plurality of current shunt control signals for separately controlling the current shunts. Each of the current shunt control signals is generated according to the sensed brightness of the corresponding light emitting unit and is used in controlling the conduction statement of the current bypass provided by the corresponding current shunt, so that the brightness of the corresponding light emitting unit is adjusted.

In some embodiments of the invention, each of the current shunts is implemented by a switch coupled in parallel with the corresponding light emitting unit. The conduction statement of each switch is controlled by the corresponding current shunt control signal. The current shunt control signal may be a pulse width modulation signal (PWM signal). In such cases, the control unit controls the duty cycles of the current shunt control signals separately according to the sensed brightness of the corresponding light emitting units. The brightness of the corresponding light emitting unit is increased by decreasing the duty cycle of the current shunt control signal and decreased by increasing the duty cycle of the current shunt control signal. In some cases, when the sensed brightness of a light emitting unit is too low, the control unit decreases the duty cycle of the corresponding current shunt control signal to increase the brightness, and when the sensed brightness of the light emitting unit is too high, the control unit increases the duty cycle of the corresponding current shunt control signal to decrease the brightness.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The invention can be more fully understood by reading the subsequent detailed description and examples with references made to the accompanying drawings, wherein:

FIG. 1 illustrates a conventional light emitting element array;

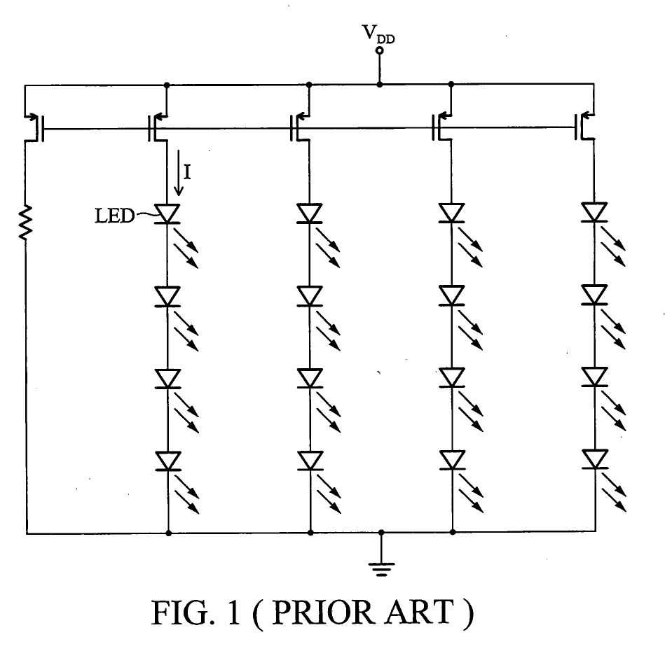

FIG. 2 illustrates an embodiment of the light source device of the invention;

FIG. 3 illustrates another embodiment of the light source device of the invention;

FIG. 4 illustrates a diagram applying the light sources to a full color image display panel, and

FIG. 5 illustrates a plurality of the red light emitting units R of the full color backlight module 402 and their corresponding red light current shunts.

### DESCRIPTION OF THE PREFERRED EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

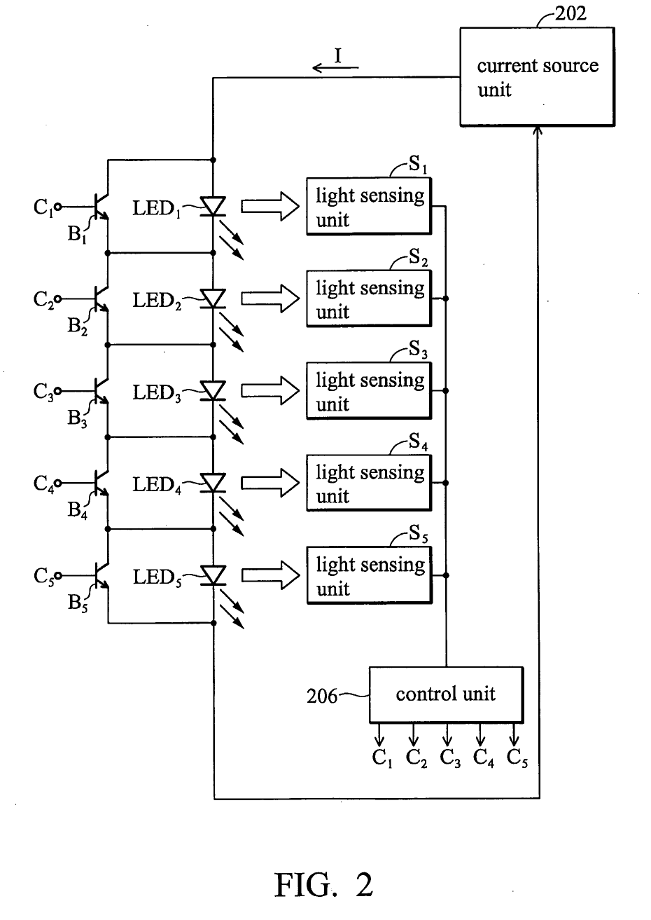

FIG. 2 illustrates an embodiment of the light source device of the invention. The light source device is applied in backlight modules of image display panels, and includes a current source unit 202, a plurality of light emitting units LED₁-LED₅, a plurality of current shunts B₁-B₅, a plurality of light sensing units S₁-S₅ and a control unit 206. The light emitting units LED₁-LED₅ are coupled in series to the current source unit 202. The current source unit 202 provides a driving current I. As shown in FIG. 2, each of the current shunts B₁-B₅ is corresponding to one of the light emitting units LED₁-LED₅, and provides a current bypass for the driving current I to bypass the corresponding light emitting unit. Each of the light sensing units S₁-S₅ is corresponding to one of the light emitting units LED₁-LED₅, and each of the light sensing units S₁-S₅ is used in sensing the brightness of the light emitting units LED₁-LED₅ correspondingly. The control unit 206 generates a plurality of current shunt control signals C₁-C₅ for the current shunts B₁-B₅, respectively. Each of the current shunt control signals C₁-C₅ is generated according to the sensed brightness of the corresponding light emitting unit and is used in controlling the conduction statement of the current bypass provided by the corresponding current shunt. The control unit 206 controls the brightness of the light emitting units LED₁-LED₅ separately by separately controlling the states of the current shunt control signals C₁-C₅.

In some embodiments, each of the current shunts B₁-B₅ is implemented by a switch coupled in parallel with the corresponding light emitting unit. The conduction statement of each switch is controlled by its corresponding current shunt control signal. In the embodiment shown in FIG. 2, the current shunts B₁-B₅ are implemented by bipolar junction transistors (BJTs). Taking the current shunt B₁ for example, the corresponding current shunt control signal C₁ is coupled to the base of the BJT (B₁) to control the conduction of the BJT (B₁). In this case, when the current shunt control signal C₁ is high, the corresponding BJT (B₁) is turned on and provides a current bypass for the driving current I. Thus, there is no current flowing through the light emitting unit LED₁, and the light emitting unit LED₁ stops illuminating.

In some embodiments of the invention, the current shunt control signals C₁-C₅ are implemented by pulse width modulation signals (PWM signals) because of human vision characteristics (persistence of vision). The brightness of each of the light emitting units LED₁-LED₅ is dependent on the duty cycle of its corresponding current shunt control signal C₁-C₅. During a short time period, the brightness from the light emitting units LED₁-LED₅ that human vision perceives is dependent on the total operating time of the light emitting unit. The greater the total operating time, the brighter perceived by human vision.

In the embodiment shown in FIG. 2, the control unit 206 controls the duty cycles of the current shunt control signals C₁-C₅ separately according to the sensed brightness of their corresponding light emitting units LED₁-LED₅. Because the conduction statement of each current bypass is dependent on its corresponding current shunt control signal, the brightness of each of the light emitting units LED₁-LED₅ may be adjusted separately. In this case, the light emitting units LED₁-LED₅ only illuminating when the corresponding current shunt does not provide current bypasses for the driving current I, and the current shunts B₁-B₅ only provide current bypasses when the corresponding current shunt control signal is high. According to pulse width modulation techniques, the shorter the duty cycle of the current shunt control signal is, the brighter the light emitting unit is. For example, when the control unit 206 decreases the duty cycle of the current shunt control signals C₁-C₅, the brightness of the corresponding light emitting units LED₁-LED₅ increases and, on the contrary, when the control unit 206 increases the duty cycle of the current shunt control signals C₁-C₅, the brightness of the corresponding light emitting units LED₁-LED₅ decreases. Therefore, for each of the light emitting units LED₁-LED₅, the control unit 206 decreases the duty cycle of the corresponding current shunt control signal when the sensed brightness of the light emitting unit is too low, and the control unit 206 increases the duty cycle of the corresponding current shunt control signal when the sensed brightness of the light emitting unit is too high. The advantage of the light source device of the embodiment of the present invention is that the brightness of the light emitting units LED₁-LED₅ is controlled separately. When any of the light emitting units LED₁-LED₅ is malfunctioned, the control unit 206 sets the current shunt control signal corresponding to the malfunctioned light emitting unit to always be high. Thus, the malfunctioned light emitting unit is provided with a current bypass and the driving current I bypasses the malfunctioned light emitting unit. The other normal light emitting units may work normally without being affected by the malfunctioned light emitting unit.

In some embodiments, each of the light emitting units LED₁-LED₅ is composed of more than one light emitting diode. Each of the light emitting units LED₁-LED₅ may be implemented by a plurality of light emitting diodes that are coupled in series, a plurality of light emitting diodes that are coupled in parallel, or any other lighting devices.

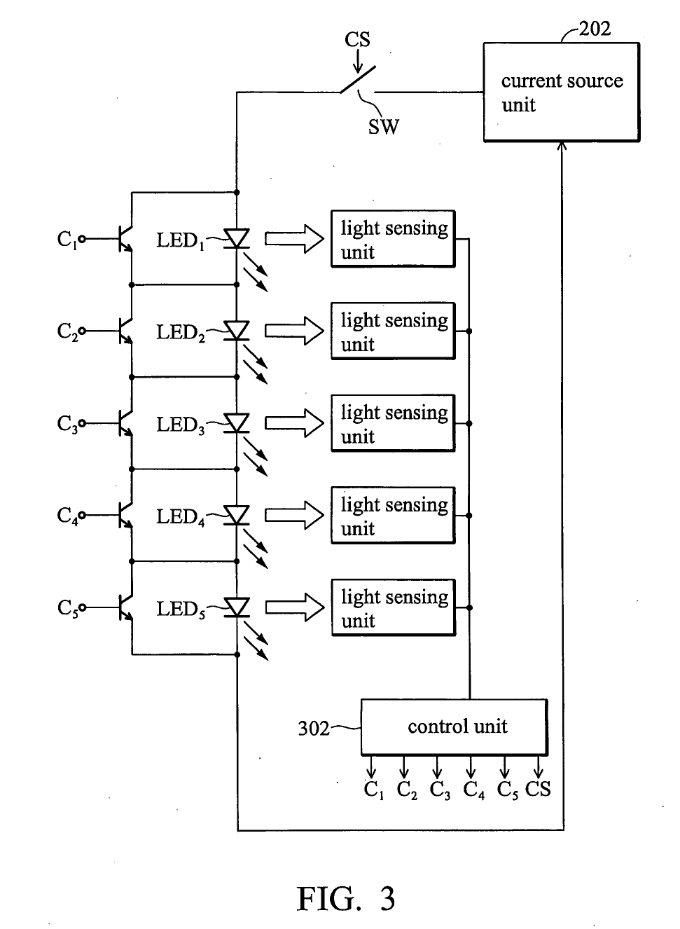

FIG. 3 illustrates another embodiment of the light source device of the invention. Compared to the embodiment shown in FIG. 2, the embodiment shown in FIG. 3 further includes a driving current switch SW coupling the light emitting units LED₁-LED₅ to the current source unit 202. Compared with the control unit 206, the control unit 302 further generates a driving current control signal CS controlling the conduction statement of the driving current switch SW. Similarly, according to human vision characteristics (persistence of vision), the driving current control signal CS may be implemented by PWM signal. The control unit 302 controls the duty cycle of the driving current control signal CS according to the brightness of the light emitting units LED₁-LED₅. When the control unit 302 increases the duty cycle of the driving current control signal CS, the brightness of every light emitting units LED₁-LED₅ increases. When the control unit 302 decreases the duty cycle of the driving current control signal CS, the brightness of every light emitting units LED₁-LED₅ decreases. Therefore, when the sensed brightness of the light emitting units LED₁-LED₅ is too low, the control unit 302 increases the duty cycle of the driving current control signal CS, and when the sensed brightness of the light emitting units LED₁-LED₅ is too high, the control unit 302 decreases the duty cycle of the driving current control signal CS.

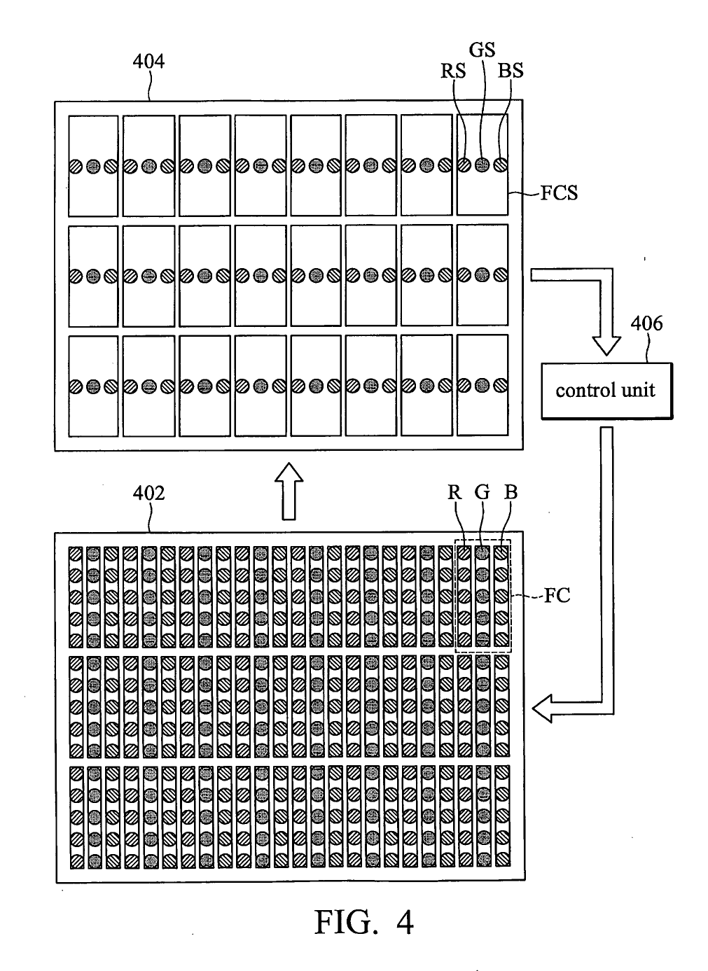

The light source device may be further applied in full color image display panels. FIG. 4 illustrates a diagram of applying the light source device to a full color image display panel. A full color backlight module 402 includes a plurality of full color light emitting blocks FC, each including a red light emitting unit R, a green light emitting unit G and a blue light emitting unit B. For each red light emitting unit R, a red light current shunt (not shown in FIG. 4) is provided. For each green light emitting unit G, a green light current shunt (not shown in FIG. 4) is provided. For each blue light emitting unit B, a blue light current shunt (not shown in FIG. 4) is provided. A light sensing device 404 includes a plurality of full color light sensing blocks FCS corresponding to the full color light emitting blocks FC. Each of the full color light sensing blocks FCS includes a red light sensing unit RS sensing the red light emitted from the corresponding red light emitting unit R, a green light sensing unit GS sensing the green light emitted from the corresponding green light emitting unit G, and a blue light sensing unit BS sensing the blue light emitted from the corresponding blue light emitting unit B. According to the sensed red light, the control unit 406 generates a control signal controlling the red light current shunt corresponding to the red light emitting unit R to adjust its brightness. Similarly, according to the sensed green light, the control unit 406 generates a control signal controlling the green current shunt corresponding to the green light emitting unit G to adjust brightness. According to the sensed blue light, the control unit 406 generates a control signal controlling the blue light current shunt corresponding to the blue light emitting unit B to adjust brightness. The embodiment of the invention controls the brightness of the red, green and blue light emitting units separately.

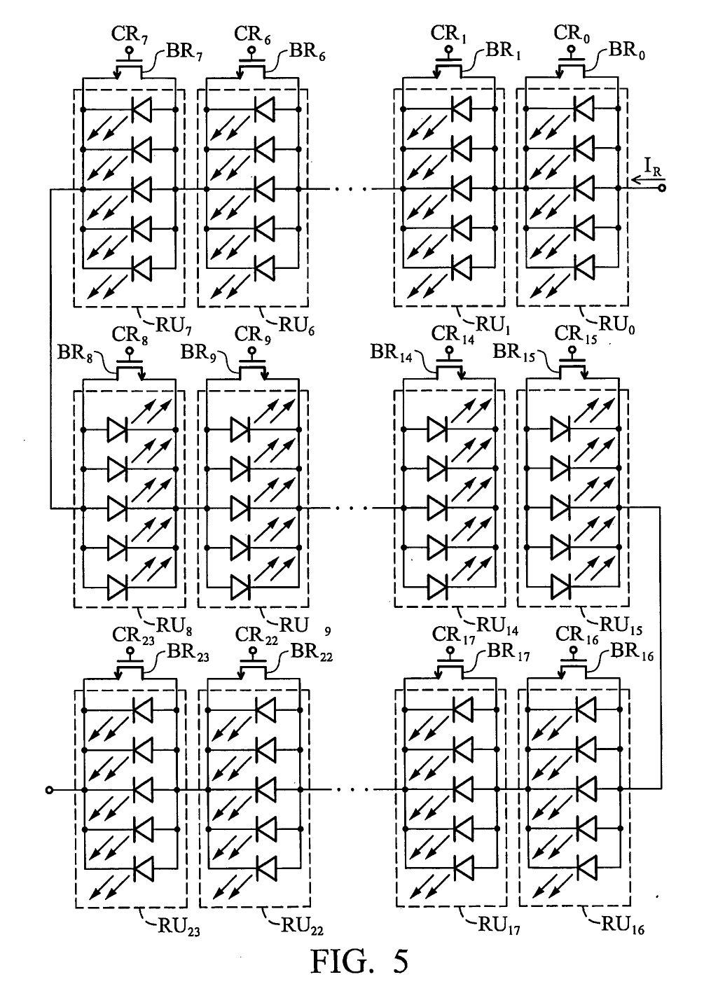

FIG. 5 illustrates a plurality the red light emitting units R of the full color backlight module 402 and their corresponding red light current shunts. In this embodiment, the full color backlight module 402 includes 24 red light emitting units RU₀-RU₂₃ coupled in series, and each of the red light emitting units RU₀-RU₂₃ is composed of five red light emitting diodes coupled in parallel. Each of the red light current shunts BR₀-BR₂₃ is corresponding to one of the red light emitting units RU₀-RU₂₃, and each of the red light current shunts BR₀-BR₂₃ is coupled in parallel to its corresponding red light emitting unit. Each of the red light current shunts BR₀-BR₂₃ provides a current bypass for the driving current IR driving the red light emitting units RU₀-RU₂₃. The control signals of the current shunts BR₀-BR₂₃ are CR₀-CR₂₃, respectively. In this case, when the control signal is high, the corresponding current shunt is turned on to provide a current bypass for the driving current I_{R} and so that the corresponding red light emitting unit stops illumination. The control signals CR₀-CR₂₃ may be implemented by PWM signals. The control unit 406 controls the duty cycles of CR₀-CR₂₃ according to the sensed brightness their corresponding red light emitting units RU₀-RU₂₃, respectively. Thus the brightness of RU₀-RU₂₃ can be adjusted separately in the embodiment of the invention.

The structure of the green light emitting units shown in FIG. 4 and their corresponding green light current shunts is similar to the structure shown in FIG. 5. The structure of the blue light emitting units shown in FIG. 4 and their corresponding blue light current shunts is similar to the structure shown in FIG. 5.

The light source device of the embodiments of the invention controls the brightness of the light emitting units separately. Compared to conventional techniques, image display panels with the light source devices according to the embodiments of the invention provide more uniform brightness. When any light emitting unit of the light source device according to the embodiments of the invention is malfunctioned, the control unit according to the embodiments of the invention enables the corresponding current shunt to always provide a current bypass for the driving current to bypass the malfunctioned light emitting unit. Thus, properly operating light emitting units can perform normally without being affected by the malfunctioned light emitting unit.

Furthermore, the embodiments of the invention may dynamically adjust the current shunt control signals when displaying video. According to each image of the displayed video, the embodiments of invention increases the brightness of the light emitting units driven by high gray levels and decreases the brightness of the light emitting units driven by low gray levels. Thus, image contrast is improved by the embodiments of invention.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source device applied in a backlight module, comprising:
a current source unit, for providing a driving current;
a plurality of light emitting units, coupled in series to the current source unit;
a plurality of current shunts, providing current bypasses to the light emitting units corresponding to the current shunts respectively;
a plurality of light sensing units, for sensing the brightness of the light emitting units corresponding to the light sensing units respectively; and
a control unit, generating a plurality of current shunt control signals according to the brightness of the light emitting units, wherein the current shunt control signals are corresponding to the current shunts respectively, and control a conduction statement of each of the current bypasses in order to control the brightness of the light emitting units.

2. The light source device as claimed in claim 1, wherein each of the current shunts is implemented by a switch coupled in parallel with the corresponding light emitting unit, and the conduction statement of each of the current shunts is controlled by the corresponding current shunt control signal.

3. The light source device as claimed in claim 2, wherein each of the current shunt control signals is a pulse width modulation signal.

4. The light source device as claimed in claim 3, wherein the control unit controls the duty cycle of each of the current shunt control signals according to the brightness of the corresponding light emitting unit.

5. The light source device as claimed in claim 4, wherein, for each of the light emitting units, the control unit decreases the duty cycle of the corresponding current shunt control signal to increase the brightness of the light emitting unit.

6. The light source device as claimed in claim 4, wherein, for each of the light emitting units, the control unit increases the duty cycle of the corresponding current shunt control signal to decrease the brightness of the light emitting unit.

7. The light source device as claimed in claim 1, further comprising a driving current switch coupling the light emitting units to the current source unit.

8. The light source device as claimed in claim 7, wherein the control unit further generates a driving current control signal for controlling a conduction statement of the driving current switch.

9. The light source device as claimed in claim 8, wherein the driving current control signal is a pulse width modulation signal.

10. The light source device as claimed in claim 9, wherein the control unit controls the duty cycle of the driving current control signal according to the brightness of the light emitting units.

11. The light source device as claimed in claim 10, wherein the control unit increases the duty cycle of the driving current control signal to increase the brightness of the light emitting units.

12. The light source device as claimed in claim 10, wherein the control unit decreases the duty cycle of the driving current control signal to decrease the brightness of the light emitting units.
